(19) United States
(12) Patent Application Publication
(10) Pub. No.: US 2006/0092459 A1
(43) Pub. Date: May 4, 2006

(54) Image forming system, image forming device employing the same, and external terminal control program

(75) Inventors: Shinichi Kimura, Osaka (JP); Keiko Morita, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: Fujicopian Co., Ltd., Osaka-shi (JP)

(21) Appl. No.: 11/258,861

(22) Filed: Oct. 27, 2005

(30) Foreign Application Priority Data
Nov. 1, 2004 (JP) 2004-318077

(51) Int. Cl. G06F 3/12

(52) U.S. Cl. 358/1.15

(57) ABSTRACT

A copier 2 comprises a document reading unit 50 for acquiring image data from a document, a HDD 150 for storing the document image data, a device main body 20 for delivering while printing on a recording paper an image based on the document image data, a control unit 100 for controlling the operation of the device main body 20, and a network I/F unit 170 capable of data transmission and reception with an external terminal 3 through a network 4. In addition, the control unit 100 transmits via the network 4 to the external terminal 3 the image data stored in the HDD 150 to be displayed by the external terminal 3, and when the setting information for controlling the operation of the device main body 20 has been received from the external terminal 3 via the network 4, operates the device main body 20 according to the setting information.

### FIELD OF THE INVENTION

The present invention relates to an image forming system, and an image forming device and a storage medium for an external terminal control program used therein; in particular, it relates to an image forming system, wherein the printing function of an image forming device can be set using an external terminal. Further, it relates to a storage medium for an external terminal control program of a computer employed as an external terminal for such an image forming system.

### BACKGROUND INFORMATION

In recent years, image forming devices, for instance copiers, are provided with various functions such as: functions for changing the copy scale factor for the document to be copied, functions for changing the printing density, double-sided printing functions or combined copying functions that combine a plurality of document images on a single recording paper for image forming, sorting functions for sorting and delivering recording papers after printing, and after-processing functions for performing stapling processes or punching processes on a stack of recording paper after printing. In such highly functional image forming devices, a control panel provided with an operation switch and a display unit, such as a liquid crystal display unit, is implemented for users to set these functions. However, as function setting is complicated due to the many functions, there are inconveniences, such as a user occupying the control panel of an image forming device over a long period of time when inputting function settings, or inabilities to obtain an output result as desired by the user due to difficulties that the user has in predictting the result of the function setting.

Thus, image forming devices are known, which use an image forming device and an external terminal device connected through a network, such as a personal computer, and make it unnecessary for the user to occupy the control panel of the image forming device for a long period of time when entering the function setting, and make it easier for the user to predict the result of function setting by displaying, with a frame on the screen of a personal computer, the location or the like of the image that will be printed on the recording paper according to the function setting entered by the user.

In cases where, as described above, it is made easier for the user to predict the result of the function setting by displaying, with a frame on the screen of a personal computer, the location or the like of the image that will be printed on the recording paper, according to the function setting entered by the user, there is a disadvantage in that it is difficult for the user to perform function setting as intended, as the content of the image that will be printed on the recording paper, such as for instance, the printing density, is not displayed on the screen of the personal computer.

The present invention was devised as a result of earnest studies into these issues, and an object thereof is to provide an image forming system wherein setting a function as intended is easy, and an image forming device and storage medium for an external terminal control program used therein.

### SUMMARY OF THE INVENTION

The invention as recited in Claim 1 is an image forming device comprising an image data acquisition unit for acquiring image data, a first image storage unit for storing the image data acquired by the image data acquisition unit, a printing function unit for delivering while printing on a recording paper an image based on the image data stored by the first image storage unit, a first control unit for controlling the operation of the printing function unit, and a first communication unit capable of data transmission and reception through a network with an external terminal device, wherein the first control unit causes the first communication unit to transmit, through the network to the external terminal device, the display data based on the image data stored by the first image storage unit so as to be displayed by the external terminal device, and when the setting information for controlling the operation of the printing function unit has been received by the first communication unit through the network from the external terminal device, operates the printing function unit according to the setting information.

The invention as recited in Claim 2 is the image forming device as recited in Claim 1, wherein the first control unit, based on the image data stored by the first image storage unit, transmits as display data the expected image data representing the image expected to be printed on the recording paper by operating the printing function unit according to the received setting information.

The storage medium for an external terminal control program as recited in Claim 3 is a storage medium for storing an external terminal control program for operating as an external terminal a computer comprising a second communication unit capable of data transmission and reception through a network with the image forming device as recited in Claim 1, a display unit for displaying an image, and a terminal side operation unit for receiving operation input, wherein the external terminal control program causes the computer to function as a received data display means for making the second communication unit receive display data to be displayed by the display unit from the image forming device through the network and for displaying the received display data on the display unit, and a setting information transmission means for, when setting information for controlling the printing operation by the image forming device has been received by the terminal side operation unit, causing the second communication unit transmit the received setting information through the network to the image forming device.

The storage medium for an external terminal control program as recited in Claim 4 is a storage medium for storing an external terminal control program for operating as an external terminal a computer comprising a second communication unit capable of data transmission and reception through the network with the image forming device as recited in Claim 1, a display unit for displaying an image, a second image storage unit for storing image data, and a terminal side operation unit for receiving operation input, wherein the external terminal control program causes the computer to operate as a display data acquisition means for causing the second communication unit to receive display data to be displayed by the display unit from the image forming device through the network while causing the second image storage unit to store the received display data, an expected image display means for, when setting information for controlling the printing operation by the image forming device has been received by the terminal side operation unit, generating, based on the display data stored in the second image storage unit, expected image data representing an image expected to be printed on the recording paper by operating the image forming device in response to the received setting information, and displaying the generated expected image data on the display unit, and a setting information transmission means for, when the setting information has been received, further causing the second communication unit to transmit the received setting information through the network to the image forming device.

In the image forming system as recited in Claim 5, an external terminal device comprising a second communication unit capable of data transmission and reception through a network with the image forming device as recited in Claim 1, a display unit for displaying an image, a terminal side operation unit for receiving operation input, and a second control unit for causing the second communication unit to receive display data to be displayed by the display unit from the image forming device through the network and for displaying the received display data on the display unit, and when setting information for controlling the printing operation by the image forming device has been received by the terminal side operation unit, causing the second communication unit to transmit the received setting information through the network to the image forming device, and the image forming device as recited in Claim 1 are connected through the network in a data transmission and reception capable manner.

In the image forming system as recited in Claim 6, an external terminal device comprising a second communication unit capable of data transmission and reception through a network with the image forming device as recited in Claim 1, a display unit for displaying an image, a second image storage unit for storing image data, a terminal side operation unit for receiving operation input, and a second control unit for causing the second communication unit to receive display data to be displayed by the display unit from the image forming device through the network while causing the second image storage unit to store the received display data, when setting information for controlling the printing operation by the image forming device has been received by the terminal side operation unit, generating, based on the display data stored in the second image storage unit, expected image data representing an image expected to be printed on the recording paper by operating the image forming device in response to the received setting information, and displaying the generated expected image data on the display unit, and, when setting information has been received, further causing the second communication unit to transmit the received setting information through the network to the image forming device, and the image forming device as recited in Claim 1 are connected through the network in a data transmission and reception capable manner.

In the invention recited in Claim 7, the image forming device further comprises a device side operation unit for receiving input of the setting information, the external terminal device displaying a guide image that mimics the appearance of the device side operation unit so as to guide the operation of the terminal side operation unit when receiving the setting information with the terminal side operation unit.

According to the invention as recited in Claim 1, display data based on image data acquired by the image data acquisition unit is transmitted to the external terminal device through the network so as to be displayed by the external terminal device. Then, when the setting information for controlling the operation of the printing function unit is received from the external terminal device through the network, an image based on the image data is delivered while being printed on a recording paper by the printing function unit according to the setting information. In this way, as the user can carry out function setting of the image forming device using the external terminal device while verifying the display based on the image data subject to printing displayed by the external terminal device, carrying out function setting as intended by the user is easy.

According to the invention as recited in Claim 2, as the expected image data representing image expected to be printed on the recording paper by operating the printing function unit according to the setting information received by the external terminal device is transmitted from the image forming device to the external terminal device through the network so as to be displayed by the external terminal device, the status of the recording paper obtained by the image forming device based on the setting information entered by the user using the external terminal device can be displayed on the external terminal device, and carrying out function setting as intended by the user is easy.

According to the invention as recited in Claim 3, when the external terminal control program is executed, the display data based on the image data subject to printing by the image forming device received through the network is displayed by the display unit of the computer. Then, when the setting information for controlling the printing operation by the image forming device is received by the terminal side operation unit of the computer, the received setting information is transmitted from the computer through the network to the image forming device. In this way, the user can carry out function setting of the image forming device using the computer while verifying the display based on the image data subject to printing that is displayed on the display unit of the computer, so that carrying out function setting as intended by the user is easy.

According to the invention as recited in claim 4, when the external terminal control program is executed, the display data based on the image data subject to printing by the image forming device received through the network is stored while being displayed by the computer. Then, when the setting information for controlling the printing operation by the image forming device is received by the terminal side operation unit of the computer, the expected image data representing the image expected to be printed on the recording paper by operating the image forming device according to the received setting information is displayed on the display unit of the computer, based on the stored display data. In this way, the status of the recording paper that will be obtained by the image forming device based on the setting information entered by the user using a computer can be displayed by the display unit of the computer, so that carrying out function setting as intended by the user is easy.

According to the invention as recited in Claim 5, the external terminal device displays display data based on image data subject to printing received from the image forming device through the network. Then, when the setting information for controlling the printing operation by the image forming device is received by the terminal side operation unit, the received setting information is transmitted from the external terminal device through the network to the image forming device. In this way, the user can carry out function setting of the image forming device using the external terminal device while verifying the display based on the image data subject to printing displayed by the external terminal device, so that carrying out function setting as intended by the user is easy.

According to the invention as recited in Claim 6, display data based on image data subject to printing is transmitted from the image forming device through the network to the external terminal device. Then, when the input of the setting information for controlling the printing operation by the image forming device is received by the external terminal device, the expected image data representing the image expected to be printed on the recording paper by carrying out printing according to this setting information is generated and displayed. Further, this setting information is transmitted from the external terminal device through the network to the image forming device, and printing onto the recording paper is carried out by the image forming device based on the setting information and the image data subject to printing. In this way, the status of the recording paper that will be obtained by the image forming device based on the setting information entered by the user can be displayed by the external terminal device, so that carrying out function setting as intended by the user is easy.

According to the invention as recited in Claim 7, as a guide image that mimics the appearance of the device side operation unit is displayed on the external terminal device so as to guide the operation of the terminal side operation unit, the user can operate the terminal side operation unit similarly to the operation of the device side operation unit when entering setting information using the terminal side operation unit, making entering setting information easy.

### BRIEF DESCRIPTION OF THE DRAWINGS

FIG. 1 is a block diagram showing one example of constitution of an image forming system according to one embodiment of the present invention.

FIG. 2 is a side view showing an outline of the internal constitution of the copier shown in FIG. 1.

FIG. 3 is a functional block diagram schematically showing the constitution of the copier shown in FIG. 2 and the external terminal shown in FIG. 1.

FIG. 4 is a flowchart for explaining the operation of the copier and the external terminal shown in the FIG. 1.

FIG. 5 is a view showing an example of document images to be read by the copier shown in FIG. 1.

FIG. 6 is a screen view showing one example of screen displayed by the display unit of the external terminal shown in FIG. 1.

FIG. 7 is a screen view showing one example of screen displayed by the display unit of the external terminal shown in FIG. 1.

FIG. 8 is a flowchart for explaining the operation of an variant of the copier and external terminal shown in the FIG. 1.

### DETAILED DESCRIPTION OF THE PREFERRED EMBODIMENTS

Hereinafter, an embodiment according to the present invention will be described with reference to the figures. Note that, in each figure, like structures are indicated by like reference numerals, whose description will be omitted.

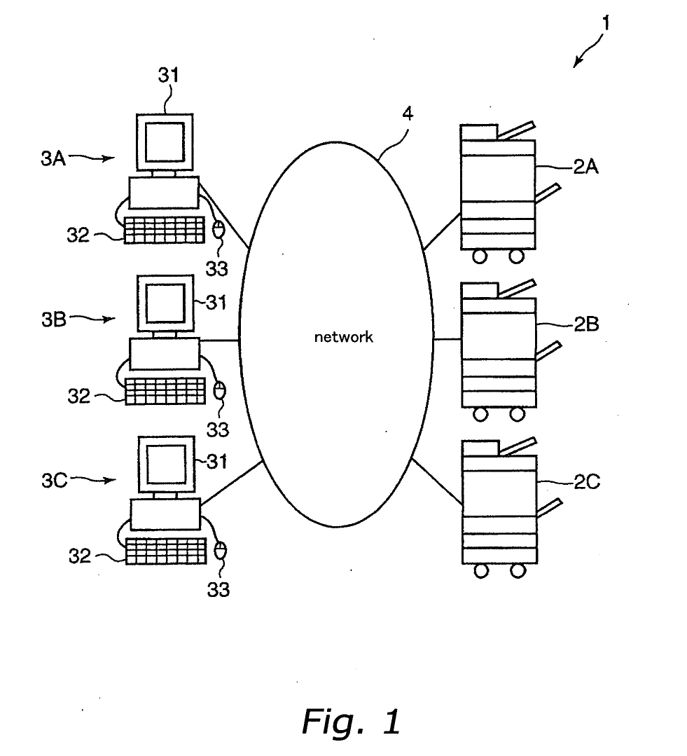

FIG. 1 is a block diagram showing one example of constitution of an image forming system according to one embodiment of the present invention. In the image forming system 1 shown in FIG. 1, for instance, three copiers 2 (copiers 2A, 2B and 2C), which are examples of image forming devices and, for instance, three external terminals 3 (external terminals 3A, 3B and 3C) constituted using personal computers, are connected through a network 4 in a data transmission and reception capable manner.

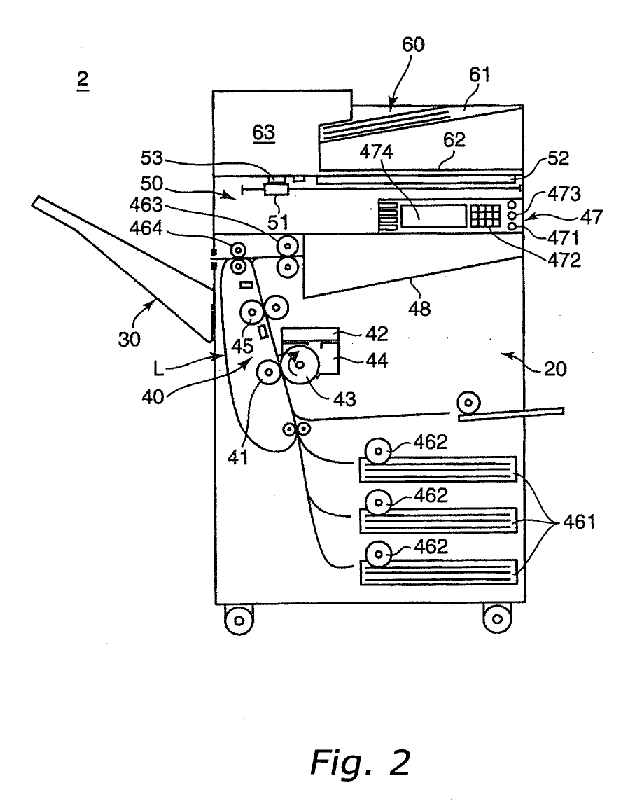

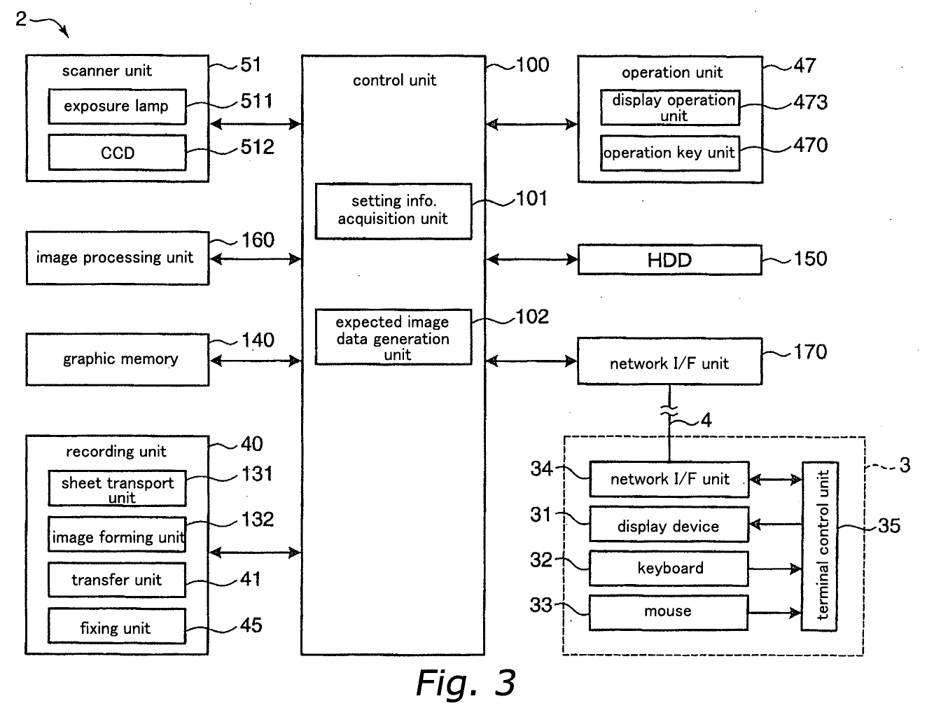

FIG. 2 is a side view schematically illustrating the internal constitution of the copier 2 shown in FIG. 1. In addition, FIG. 3 is a functional block diagram schematically illustrating the constitution of the copier 2 shown in FIG. 2 and the external terminal 3 shown in FIG. 1. Referring to FIG. 2, the copier 2 comprises a device main body 20, a stacking tray 30 installed on the left side of the device main body 20, a document reading unit 50 installed above the device main body 20, and a document feeding unit 60 installed above the document reading unit 50.

In addition, an operation unit 47 is provided at the front of the copier 2. This operation unit 47 comprises a start key 471 for the user to enter the printing execution instruction, a numeric keypad 472 for entering the number of records or the like, a document read key 473 for entering the document read start instruction, and a display operation unit 474 consisting of a liquid-crystal display or the like for displaying operation guide information or the like for various copy operations, and having a touch panel function for these various setting inputs. Furthermore, the operation unit 47 receives operation input by the user to obtain setting information for controlling the operation of the device main body 20, such as, for instance, copy scale factor setting for copying a document, printing density setting, setting for specifying double-sided printing, or setting for specifying combined copying to form image by combining a plurality of document images on one recording paper, and setting of sorting functions for sorting and delivery of recording papers after printing; and the operation unit 47 outputs the same to the control unit 100.

The document reading unit 50 comprises a scanner unit 51 consisting of a CCD (Charge Coupled Device) sensor and an exposure lamp or the like, and a document holder 52 and a document reading slit 53, which are made from a transparent material such as glass. The scanner unit 51 is so constituted as to be drivable by a drive unit, not shown; and when reading a document that is placed on the document holder 52, it is moved along the document face opposite the document holder 52, and while scanning the document image, outputs the acquired image data to the control unit 100. In addition, when reading a document fed by the document feeding unit 60, the scanner unit 51 is moved to a position opposite to the document reading slit 53, acquires the image of the document through the document reading slit 53 synchronously with the document transport action by the document feeding unit 60, and outputs the image data to the control unit 100.

The document feeding unit 60 comprises a document loading unit 61 for loading documents, a document output unit 62 for outputting a document whose image has been read, and a document transport mechanism 63 consisting of a paper feed roller (not shown) and a transport roller (not shown) for pulling out one by one and transporting to a position opposite to the document reading slit 53 the documents loaded on the document loading unit 61, and for outputting it into the document output unit 62, and the like. The document transport mechanism 63 further comprises a sheet reversing mechanism (not shown) for reversing the front and back sides of the document and transporting it again to the position opposite to the document reading slit 53, allowing the images on both sides of the document to be read from the scanner unit 51 through the document reading slit 53.

In addition, the document feeding unit 60 is provided rotatably with respect to the device main body 20, such that the front side thereof is movable in the upward direction. This allows the user to place a document to be read such as, for instance, a book in an open state, on the upper surface of the document holder 52 by moving the front side of the document feeding unit 60 upward to free the upper surface of the document holder 52.

The device main body 20 comprises a plurality of paper feeding cassettes 461, a paper feeding roller 462 for pulling one by one a recording paper out from the paper feeding cassette 461 and transporting it to a recording unit 40, and a recording unit 40 for generating and printing an image on the recording paper transported from the paper feeding cassette 461. The recording unit 40 comprises an optical unit 42 for exposing a photosensitive drum 43 by irradiating it with a laser beam or the like in accordance with the image data acquired with the scanner unit 51, a development unit 44 for forming a toner image on the photosensitive drum 43, a transfer unit 41 for transferring the toner image on the photosensitive drum 43 to the recording paper, a fixing unit 45 for fixing the toner image onto the recording paper by heating the recording paper onto which the toner image has been transferred, and transport rollers 463 and 464, or the like, provided in the sheet transport path within the recording unit 40, for transporting the recording paper to the stacking tray 30 or the output tray 48.

In addition, when forming images on both sides of a recording paper, an image is formed on one face of the recording paper with the recording unit 40, then, this recording paper is nipped by the transport roller 463 on the output tray 48 side. In this state, the transport roller 463 is reversed to switch the recording paper back, the recording paper is sent into the sheet transport path L and transported again in the region upstream from the recording unit 40, an image is formed on the other face by the recording unit 40, then the recording paper is output into the stacking tray 30 or the output tray 48.

The stacking tray 30 stacks the recording papers output by the transport roller 464. Then, according to the number thereof stacked, the stacking tray 30 is shifted vertically by a drive mechanism, not shown, to catch the recording papers output by the transport roller 464. Furthermore, when the sorting function is set, the stacking tray 30 is moved, for instance, by one unit of sorted recording paper stack in a direction perpendicular to the direction of recording paper output (in the direction of the depth of the paper surface in FIG. 2) by a drive mechanism, not shown, in response to a control signal from the control unit 100, to shift the position of the stacking layer by one unit of sorted recording paper stack.

Referring to FIG. 3, the copier 2 comprises a control unit 100, which governs the operation control of the entire device. A scanner unit 51 consisting of an exposure lamp 511 and a CCD 512, or the like, capable of reading a document image, an image processing unit 160, a sheet transport unit 131, an image forming unit 132, a recording unit 40 consisting of a transfer unit 41 and a fixing unit 45, or the like, and a network I/F unit 170 constituted in a data transmission and reception capable manner with an external terminal 3 through a network 4, are connected to this control unit 100. In addition, a graphic memory 140 where document data or the like read with the scanner unit 51 are temporarily saved, and a high capacity HDD (Hard Disk Drive) 150 having a storage capacity that can store a large quantity of document data, are connected to the control unit 100.

When the document is read by the scanner unit 51, the image processing unit 160 converts the analog image signal sent out by the scanner unit 51 into a digital image, performs image processing to improve the image quality, and then converts it into a compressed image. Then, the image processing unit 160 causes the graphic memory 140 or the HDD 150 to store this compressed image. In addition, the image processing unit 160 expands the compressed data to perform image processing suitable for the output state. For instance, in case of a laser exposure, it performs analog modulation into a laser signal. Printout is carried out by the recording unit 40 based on this analog modulation signal.

Furthermore, in response to control signal from the control unit 100, the image processing unit 160, for instance, modifies the printing density by adjusting the intensity of the laser signal, changes the copy scale factor by controlling the position of the laser illumination, and, based on the image data stored in in the graphic memory 140 or the HDD 150, for instance, generates image data in which a plurality of document images are combined onto a single recording paper so as to perform combined copying.

The control unit 100 is constituted by providing of, for example, a microprocessor or the like, and functions as a setting information acquisition unit 101 for acquiring setting information from the external terminal 3 connected to the network 4 by executing a predetermined program, as well as functioning as an expected image data generation unit 102 for generating expected image data representing the image that is expected to be printed on the recording paper by operating the device main body 20 according to the setting information, by executing a predetermined image processing program. Finally, the control unit 100 controls the operation of the scanner unit 51, the image processing unit 160, the recording unit 40, and the network I/F unit 170, based on a control program, in the following manner.

The external terminal 3 is constituted using, for instance, a personal computer and comprises a display device 31 such as, for instance, a CRT (Cathode Ray Tube) display, a keyboard 32 and a mouse 33 for receiving operation input from the user, a network I/F unit 34 capable of data transmission and reception with the copier 2 through the network 4, and a terminal control unit 35 constituted by providing a microprocessor or the like. Then, by executing a predetermined external terminal control program to cause the personal computer to function as a received data display means and a setting information transmission means, the external terminal 3 causes the display device 31 to display the image data transmitted by the copier 2, and operation guide information or the like for various copy operations, as described hereinafter. Then, by receiving operation inputs from the user, for instance, with the mouse 33 and the keyboard 32, the external terminal 3 obtains setting information for controlling the operation of the device main body 20, such as, for instance, copy scale factor setting for copying a document, printing density setting, setting for specifying double-sided printing, or setting for specifying combined copying to form an image by combining a plurality of document images on one sheet of recording paper, and setting of sorting functions for sorting and delivery of sheets of recording paper after printing, and transmits the same via the network 4 to the copier 2.

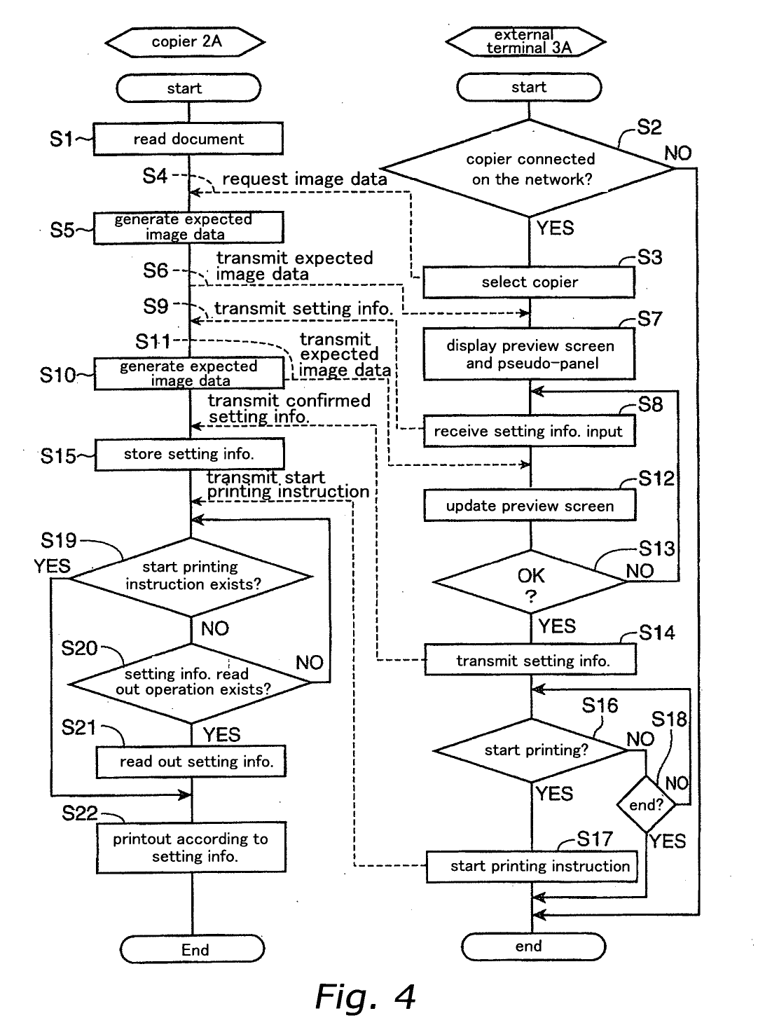

Next the operation of the image forming system 1 constituted in this manner will be described. Hereinafter, taking as example the case where the copier 2A and the external terminal 3A are used in the image forming system 1, the operation thereof will be described. FIG. 4 is a flowchart for describing the operation of the copier 2A and the external terminal 3A. In addition, FIG. 4 combines a sequence view showing signal transaction between the copier 2A and the external terminal 3A.

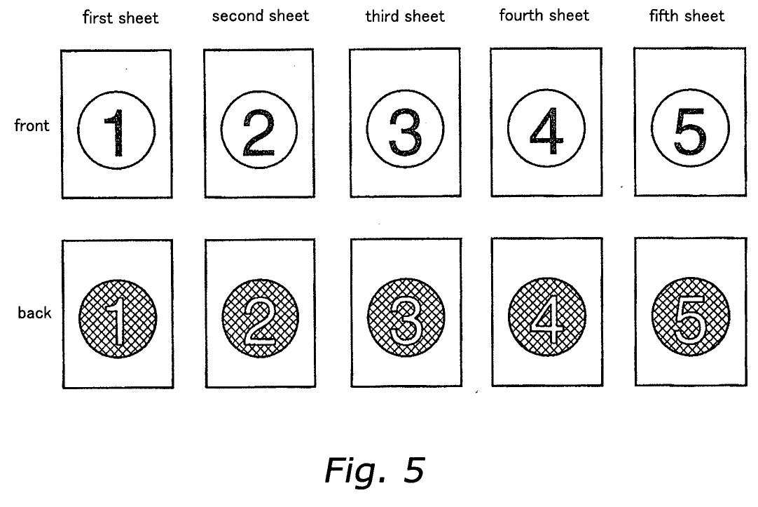

First, for instance, a document stack of double-sided documents is loaded on the document loading unit 61 in the copier 2A by the user. Then, for instance, a double-sided document reading setting by the user is received by the display operation unit 474, and when the document read key 473 is further pressed down, a control signal instructing to start a double-sided document read is output from the operation unit 47 to the control unit 100. Then, in response to the control signal from the control unit 100, the documents are sequentially transported to a position opposite to the document reading slit 53 by the document transport mechanism 63; further, each document is inverted by a sheet reversing mechanism, not shown, and transported again to the position opposite to the document reading slit 53. Meanwhile, image data of the document is acquired by the scanner unit 51 through the document reading slit 53, synchronously with the document transport action by the document feeding unit 60. In this case, the image data of both the front and back sides of the document is acquired by the scanner unit 51, as shown in FIG. 5. Then, the acquired image data is output from the scanner unit 51 to the HDD 150, and stored by the HDD 150 (step S1).

Next, when a setting program for setting the setting information in the copier 2 is started up by the user in the external terminal 3A, the copier 2 connected to the network 4 is searched by the terminal control unit 35. Then, on one hand, if there is no copier 2 connected to the network 4, as the setting information cannot be set, the program execution is terminated (NO in step S2), and on the other hand, if a copier 2 is connected to the network 4, the program execution is switched over to step S3 so as to select the target copier 2 to be set with the setting information (YES in step S2).

As there are currently three copiers 2A, 2B and 2C connected to the network 4 in step S3, the copiers 2A, 2B and 2C are displayed so as to be selectable on the screen of the display device 31. Then, selection by the user of the copier 2A, for instance using the mouse, prompts the copier 2A to be identified in the terminal control unit 35 as being the target copier to be set with the setting information (step S3), and an image data request for requesting the image data subject to printing is transmitted from the network I/F unit 34 to the copier 2A (step S4).

Next, in the copier 2A, the image data request from the external terminal 3A is received via the network 4 while being output to the control unit 100 by the network I/F unit 170. Then, the expected image data representing the image expected to be printed on the recording paper by operating the device main body 20 based on the image data stored in HDD 150, that is to say, the image data of both the front and back sides of the document shown in FIG. 5 and the setting information, is generated by the expected image data generation unit 102 in the control unit 100 (step S5), and this expected image data is transmitted by the network I/F unit 170 through the network 4 to the external terminal 3A (step S6). In this case, as the setting information still has not been entered at steps S5 and S6, the expected image data with the setting of the initial values of the setting information, for instance, “one-sided copy, A4 paper, 100% copy scale factor, one copy set”, is transmitted to the external terminal 3A.

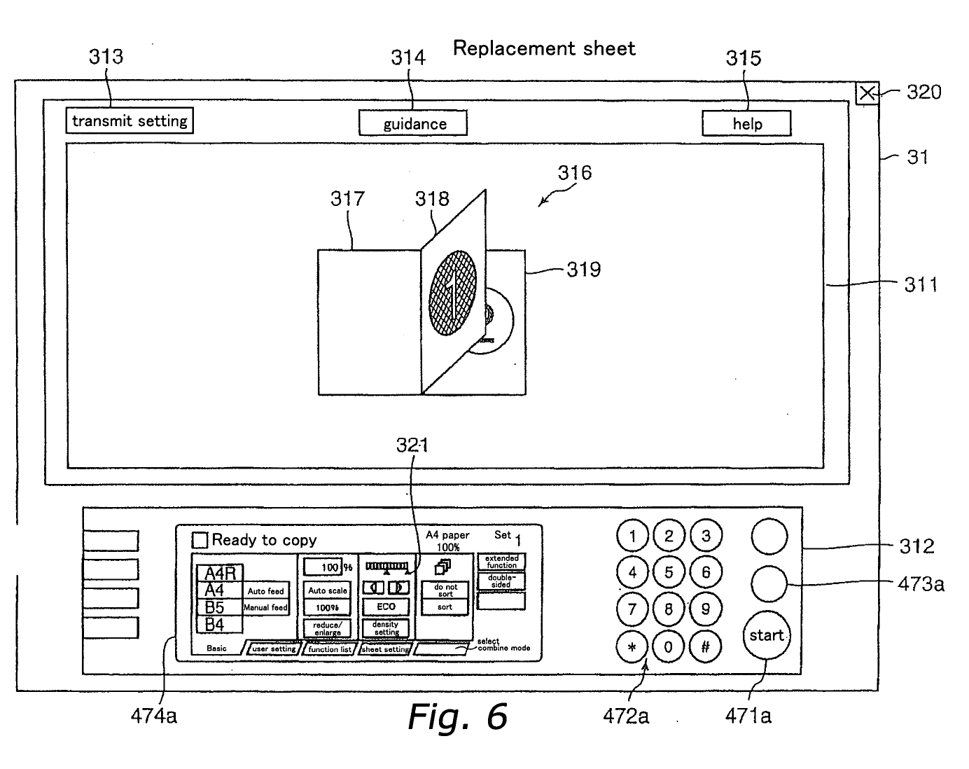

Next, in the terminal control unit 35, the expected image data from the copier 2A is received via the network 4, and a preview screen based on this image data and a pseudo-panel screen for guiding input of setting information are displayed by the display device 31 (step S7). FIG. 6 is a screen view showing one example of screen displayed by the display device 31 in step S6.

An expected image 316 based on the expected image data transmitted by the copier 2A is displayed on a preview screen 311. The expected image 316 graphically displays the output situation when the image data shown in FIG. 5 is printed on the recording paper with the setting “one-sided copy, A4 paper, 100% copy scale factor, one copy set”, which are the initial values of the setting information; for instance, a back side image 317 of the first recording paper 1, a front side image 318 of the second recording paper, and a front side image 319 of the third recording paper are displayed. In this case, as the setting is one-sided copy, the back side image 317 is displayed in a blank sheet state.

The pseudo-panel screen 312 is a pseudo-control panel mimicking the appearance of the operation unit 47 in the copier 2A, and comprises a start button 471a corresponding to the start key 471, numeric keypad buttons 472a corresponding to the numeric keypad 472, and a display operation screen 474a corresponding to the display screen of the display operation unit 474. Thus, as the pseudo-panel screen 312 is a pseudo-control panel mimicking the appearance of the operation unit 47 in the copier 2A and the user can enter the setting information into the external terminal 3A using the mouse 33 by performing the same operation as when entering the setting information with the operation unit 47 in the copier 2A, there is no need to learn a new operation method for entering setting information in the external terminal 3A, so that entering setting information is easy.

In addition, a setting transmission button 313 for receiving transmission instruction to transmit, from the external terminal 3A to the copier 2A, the setting information received by the external terminal 3A, a guidance button 314 for receiving instructions to display a guide screen for guiding the input of setting information, a help button 315 for receiving instructions to display a so-called help screen that shows functions, usage and the like, for the setting program, and a termination button 320 for receiving instructions to terminate the setting program, are displayed in the upper portion of the preview screen 311.

Next, when various buttons or the like in the pseudo-panel screen 312 are clicked by the user using the mouse 33 in the same way as the user enters setting information into the copier 2A using the operation unit 47, setting information for the copier 2A is received by the terminal control unit 35 (step S8). For instance, the setting information “double-sided copying, combined copying (2-up), A4 paper, two copy sets, and with sorting” is received by the terminal control unit 35.

Next, when the terminal control unit 35 detects that the start button 471a has been clicked by the mouse 33, the setting information entered by the user, that is to say, setting information specifying “double-sided copying, combined copying (2-up), A4 paper, two copy sets, and with sorting” is transmitted from the network I/F unit 34 through the network 4 to the copier 2A (step S9).

Next, in the copier 2A, the setting information from the external terminal 3A is received through the network 4 while being output to the control unit 100 by the network I/F unit 170, and this setting information is acquired by the setting information acquisition unit 101. Then, the expected image data representing the image expected to be printed on the recording paper by operating the device main body 20 based on the image data stored in the HDD 150, that is to say, the image data of both the front and back sides of the document shown in FIG. 5, and the setting information acquired by the setting information acquisition unit 101, that is to say, the setting information specifying “double-sided copying, combined copying (2-up), A4 paper, two copy sets, and with sorting”, is generated by the expected image data generation unit 102 in the control unit 100 (step S10), and this expected image data is transmitted by the network I/F unit 170 via the network 4 to the external terminal 3A (step S11).

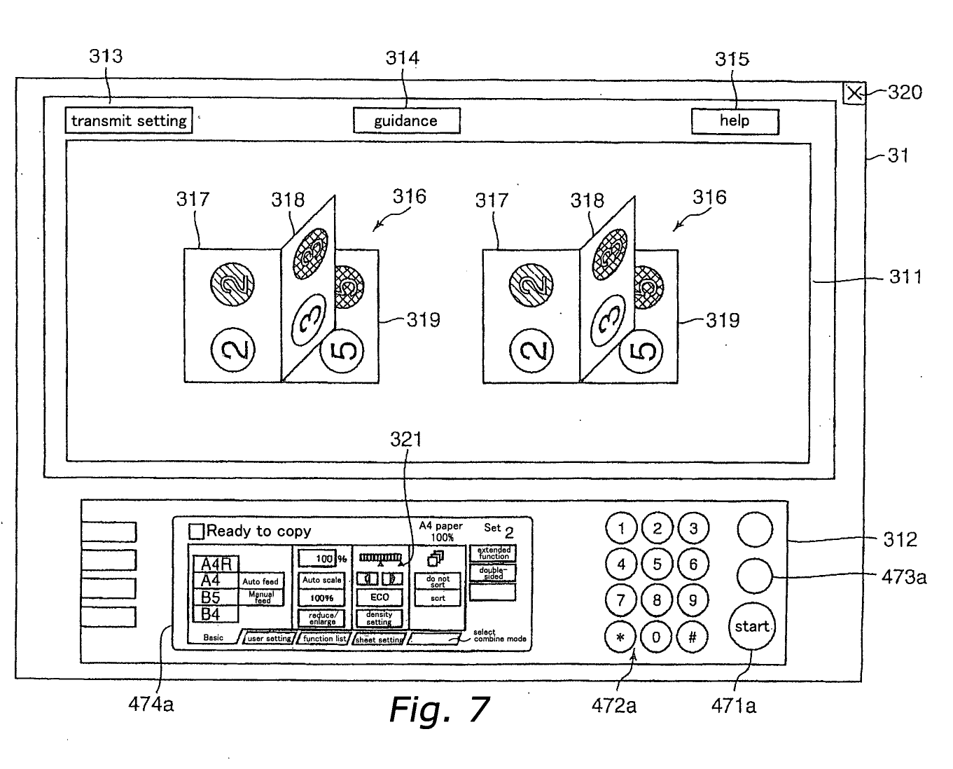

Next, in the terminal control unit 35, the expected image data from the copier 2A is received through the network 4, and a preview screen based on this image data and a pseudo-panel screen for guiding input of setting information are displayed by the display device 31 (step S12). FIG. 7 is a screen view showing one example of screen displayed by the display device 31 in step S12. On the preview screen 311 shown in FIG. 7, in the expected image 316, images of two document pages are displayed in combined states as a back side image 317 and front side images 318 and 319, respectively, according to the setting information “combined copying (2-up)”, and images of pages 3 and 4 (the second front and back) of the document are displayed as the back side image 317 according to the setting information “double-sided copying”, and two expected images 316 are displayed according to the setting information “two copy sets”. In addition, the printing images are displayed in the sorted state for the two expected images 316, according to the setting information “with sorting”.

Then, when further modifying the setting information (NO in step S13), the process switches over again to step S8, and when the terminal control unit 35 detects, for instance, that the change density key 321 has been clicked by the mouse 33 (step S8), the setting information to modify the printing density is transmitted to the copier 2A (step S9).

Next, in the copier 2A, the setting information from the external terminal 3A is received through the network 4 while being output to the control unit 100 by the network I/F unit 170, and this setting information is acquired by the setting information acquisition unit 101. Then, the expected image data representing the image expected to be printed on the recording paper by operating the device main body 20 based on the image data stored in the HDD 150, that is to say, the image data of both the front and back sides of the document shown in FIG. 5, and the setting information acquired by the setting information acquisition unit 101, that is to say, the setting information specifying “double-sided copying, combined copying (2-up), A4 paper, two copy sets, with sorting, and change printing density”, is generated by the expected image data generation unit 102 in the control unit 100 (step S10), and this expected image data is transmitted by the network I/F unit 170 via the network 4 to the external terminal 3A (step S11).

Then, in the terminal control unit 35, the expected image data from the copier 2A is received through the network 4, and a preview screen 311 based on this image data, that is to say, the image data with a modified density, and a pseudo-panel screen 312, are displayed by the display device 31 (step S12).

In this way, as the result of a printout according to setting information entered by the user, which sets various functions, such as, for instance, combined copying and density modification, can be verified on the screen of the display device 31 in the external terminal 3A, the user can easily grasp the results of function settings.

Then, if the expected image 316 displayed on the preview screen 311 is as intended by the user, the external terminal 3A detects that the setting transmission button 313 has been clicked with the mouse 33 by the user, and the setting information is confirmed. Then, the confirmed setting information is transmitted from the external terminal 3A through the network 4 to the copier 2A (step S14).

Next, in the copier 2A, the confirmed setting information from the external terminal 3A is received through the network 4 while being output to the control unit 100 by the network I/F unit 170, this setting information, that is to say, the setting information specifying “double-sided copying, combined copying (2-up), A4 paper, two copy sets, with sorting, and modify printing density”, is acquired by the setting information acquisition unit 101, and stored in the HDD 150 as the confirmed setting information (step S15).

Next, in the terminal control unit 35, if clicking of, for instance, the start button 471a with the mouse 33 by the user is detected (YES in step S16), a start printing instruction to start printing is transmitted from the external terminal 3A through the network 4 to the copier 2A (step S17).

Next, in the copier 2A, when the start printing instruction is received from the external terminal 3A through the network 4 while being output to the control unit 100 by the network I/F unit 170, and the start printing instruction is received by the control unit 100 (YES in step S19), the process switches over to step S22 so as to start printing.

Meanwhile, the user, instead of clicking the start button 471a with the mouse 33 in step S16 of the external terminal 3A, may enter a setting information read out instruction using the display operation unit 474 of the copier 2A. In this case, in step S16 of the external terminal 3A, no clicking of the start button 471a by the mouse 33 is detected (NO in step S16), and if clicking of the termination button 320 is detected (YES in step S18), the execution of the setting program is terminated, and start printing instruction is not received in the copier 2A (NO in step S19).

Then, the setting information read out instruction is received by the display operation unit 474 and output to the control unit 100 (YES in step S20), and the confirmed setting information stored in the HDD 150 is read out by the control unit 100 (step S21). In this case, for instance, when transmitting the confirmed setting information from the external terminal 3A to the copier 2A in the above step S14, the user's password may be transmitted along with the setting information, and the control unit 100 may read out the confirmed setting information stored in the HDD 150, if the user's password is received along with the setting information read out instruction by the display operation unit 474. In this way, for instance, even if confirmed setting information set by a plurality of users is stored in HDD 150, the user can read out the setting information that was set by himself/herself by entering the user's own password.

Next, in step S22, the operation of the image processing unit 160, the sheet transport unit 131, the image forming unit 132, the transfer unit 41, the fixing unit 45, and the stacking tray 30 is controlled by the control unit 100, based on either the confirmed setting information stored in the HDD 150 in step S15 or the confirmed setting information read out by the display operation unit 474 in step S21, that is to say, the setting information specifying “double-sided copying, combined copying (2-up), A4 paper, two copy sets, with sorting, and modify printing density”, and the image data stored in the HDD 150. Accordingly, image data of the document image shown in FIG. 5 is printed with combined copying (2-up) and density modified on both sides of an A4 size recording paper, and further, two copies are accumulated on the stacking tray in a sorted state.

Thus, by operating step S1 through S22, as the user can enter setting information for the copier 2 by using the external terminal 3 connected to the copier 2 through the network 4, the occurrence of a user occupying the operation unit 47 of the copier 2 for a long period of time for the input operation of the setting information can be decreased. In addition, as the result of the printout according to the setting information to set various functions entered by the user can be verified on the screen of the display device 31 in the external terminal 3, the user can easily grasp the result of a function setting.

In addition, as the expected image data is generated by the expected image data generation unit 102 in the copier 2, it is easy to accelerate the expected image data generation process and accelerate the display of the preview screen 311 in the external terminal 3, for instance, by constituting the expected image data generation unit 102 with a dedicated hardware for image processing such as an ASIC.

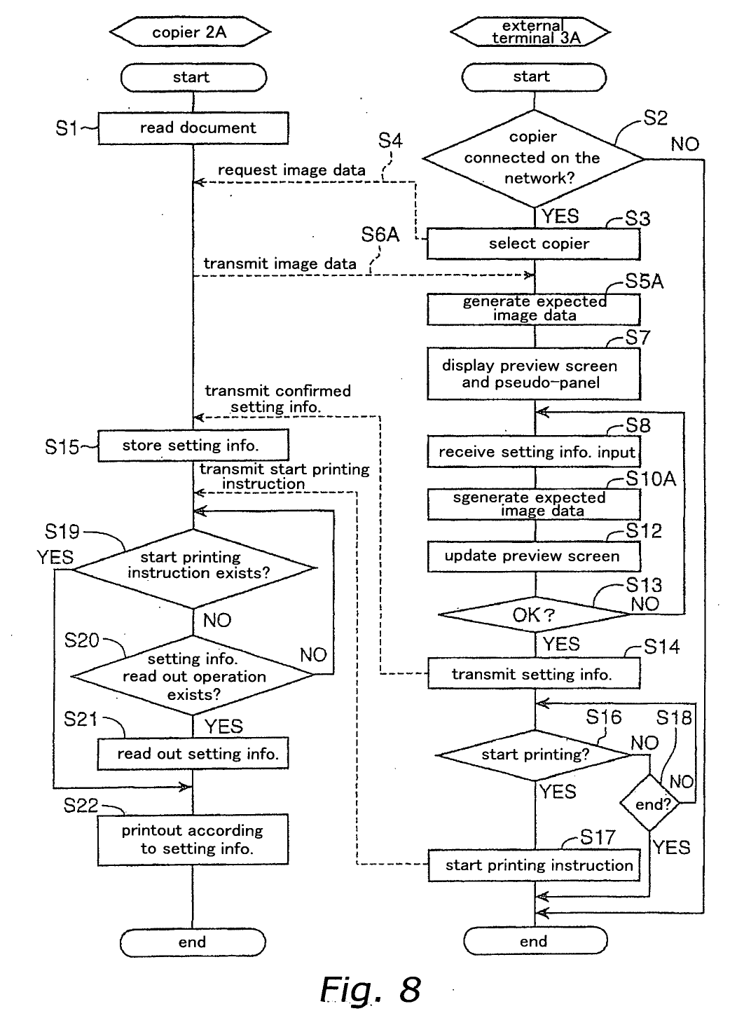

Note that, although an example wherein a copier 2 generates the expected image data has been shown, for instance, the external terminal 3 may be constituted in such a way that, by executing a predetermined external terminal control program that causes a personal computer to function as a display data acquisition means, an expected image display means, and a setting information transmission means, in step S6, the document image data stored in HDD 150 is directly transmitted from the copier 2 to the external terminal 3, and the terminal control unit 35 generates the expected image data based on the document image data and the setting information. FIG. 8 is a flowchart for explaining the operation of the copier 2A and external terminal 3A in the case where the external terminal 3 generates the expected image data. In FIG. 8, the same keys are assigned to the same steps as in FIG. 4, a description of which is omitted, and the points that differ from the flowchart shown in FIG. 4 are described.

In the flowchart shown in FIG. 8, in the copier 2A, when the image data request from the external terminal 3A is received through the network 4 by the network I/F unit 170, in response to the control signal from the control unit 100, the image data stored in the HDD 150, that is to say, the image data of both the front and the back sides of the document shown in FIG. 5 is transmitted by the network I/F unit 170 through the network 4 to the external terminal 3A (step S6A). Then, in step S5A of the external terminal 3A, the same process as in step S5 of FIG. 4 is executed based on the image data transmitted by the copier 2A to generate an expected image data (step S5A). In addition, instead of steps S9, S10 and S11 in FIG. 4, in step S10A of the external terminal 3A, the terminal control unit 35 generates the expected image data based on the setting information confirmed in step S8 and the image data transmitted from the copier 2A, and the processes downstream of step S12 are carried out based on this expected image data (step S10A).

In this case, as the external terminal 3 does not need to transmit the setting information to the copier 2 and receive a new expected image data from the copier 2 via the network 4 each time the setting information is modified by the user, the process time for data transmission and reception via the network 4 can be decreased.

In addition, double-sided copying, combined copying, sheet size setting, copy unit number, sorting setting, and density setting were shown as examples of setting information; however, the setting information is not limited to these and can be applied to various operation settings, such as, for instance copy scale factor setting for carrying out enlargement/reduction copying, after-processing setting for performing punching or stapling of recording paper onto which an image has been printed, and color setting for carrying out color copying.

In addition, the example of a copier was shown as example of image forming device; however, for instance, in a facsimile, the invention may be applied to operation settings in a facsimile device, such as transmission resolution and transmission scale factor. In addition, for instance in a printer, the invention may be applied, for instance, to the operation settings when an image transmitted from a personal computer, such as external terminal 3, to the printer is printed. In this case, the interface circuit in the printer that receives the image data from the personal computer corresponds to the image data acquisition unit.

What is claimed is:

1. An image forming device comprising an image data acquisition unit for acquiring image data, a first image storage unit for storing the image data acquired by the image data acquisition unit, a printing function unit for delivering while printing on a recording paper an image based on the image data stored by the first image storage unit, a first control unit for controlling the operation of the printing function unit, and a first communication unit capable of data transmission and reception through a network with an external terminal device, the image forming device being such that:
the first control unit causes the first communication unit to transmit, through the network to the external terminal device, the display data based on the image data stored by the first image storage unit so as to be displayed by the external terminal device, and, when the setting information for controlling the operation of the printing function unit has been received by the first communication unit through the network from the external terminal device, operates the printing function unit according to the setting information.

2. The image forming device as recited in claim 1, wherein the first control unit, based on the image data stored by the first image storage unit, transmits as display data the expected image data representing the image expected to be printed on the recording paper by operating the printing function unit according to the received setting information.

3. A storage medium for an external terminal control program for operating as an external terminal a computer comprising a second communication unit capable of data transmission and reception through a network with the image forming device as recited in claim 1, a display unit for displaying an image, and a terminal side operation unit for receiving operation input, storage medium for an external terminal control program being such that
the external terminal control program cause the computer to function as
a received data display means for causing the second communication unit to receive display data to be displayed by the display unit from the image forming device through the network and for displaying the received display data on the display unit, and
a setting information transmission means for, when setting information for controlling the printing operation by the image forming device has been received by the terminal side operation unit, causing the second communication unit to transmit the received setting information through the network to the image forming device.

4. A storage medium for storing an external terminal control program for operating as an external terminal a computer comprising a second communication unit capable of data transmission and reception through the network with the image forming device as recited in claim 1, a display unit for displaying an image, a second image storage unit for storing image data, and a terminal side operation unit for receiving operation input, the storage medium for an external terminal control program being such that
the external terminal control program causes the computer to function as
a display data acquisition means for causing the second communication unit to receive display data to be displayed by the display unit from the image forming device through the network while making the second image storage unit store the received display data,
an expected image display means for, when setting information for controlling the printing operation by the image forming device has been received by the terminal side operation unit, generating, based on the display data stored in the second image storage unit, expected image data representing an image expected to be printed on the recording paper by operating the image forming device in response to the received setting information, and displaying the generated expected image data on the display unit, and
a setting information transmission means for, when setting information has been received by the terminal side operation unit, further making the second communication unit transmit the received setting information through the network to the image forming device.

5. An image forming system, wherein an external terminal device comprising a second communication unit capable of data transmission and reception through a network with the image forming device as recited in claim 1, a display unit for displaying an image, a terminal side operation unit for receiving operation input, and a second control unit for causing the second communication unit to receive display data to be displayed by the display unit from the image forming device through the network and for displaying the received display data on the display unit, and when setting information for controlling the printing operation by the image forming device has been received by the terminal side operation unit, causing the second communication unit to transmit the received setting information through the network to the image forming device, and
the image forming device as recited in claim 1
are connected through the network in a data transmission and reception capable manner.

6. An image forming system, wherein an external terminal device comprising a second communication unit capable of data transmission and reception through a network with the image forming device as recited in claim 1, a display unit for displaying an image, a second image storage unit for storing image data, a terminal side operation unit for receiving operation input, and a second control unit for causing the second communication unit to receive display data to be displayed by the display unit from the image forming device through the network while causing the second image storage unit store the received display data, when setting information for controlling the printing operation by the image forming device has been received by the terminal side operation unit, generating, based on the display data stored in the second image storage unit, expected image data representing an image expected to be printed on the recording paper by operating the image forming device in response to the received setting information, and displaying the generated expected image data on the display unit, and when setting information has been received by the terminal side operation unit, further causing the second communication unit to transmit the received setting information through the network to the image forming device, and
the image forming device as recited in claim 1
are connected through the network in a data transmission and reception capable manner.

7. The image forming system as recited in claim 5, wherein the image forming device further comprises a device side operation unit for handing input of the setting information,
the external terminal device displaying a guide image that mimics the appearance of the device side operation unit so as to guide the operation of the terminal side operation unit when receiving the setting information with the terminal side operation unit.
